(19) United States
(12) Patent Application Publication
(10) Pub. No.: US 2007/0160754 A1
(43) Pub. Date: Jul. 12, 2007

(54) Method for coating the internal wall of a pipeline with a latex film

(76) Inventors: Helene Blaise-Graftieaux, Mulhouse (FR); Gerard Riess, Mulhouse (FR); Philippe Marteil, Vigny (FR); Jean-Marie Schwob, Noisy Le Roi (FR)

Correspondence Address: BROWDY AND NEIMARK, P.L.L.C.;624 NINTH STREET, NW, SUITE 300, WASHINGTON, DC, 20001-5303, US

(21) Appl. No.: 10/554,049

(22) PCT Filed: Apr. 22, 2004
(86) PCT No.: PCT/FR04/00985

§ 371 Date: Oct. 26, 2006

(30) Foreign Application Priority Data
Apr. 22, 2003 (FR) 03/04925

(51) Int. Cl. B05D 7/22; B05D 3/02

(52) U.S. Cl. 427/230; 427/384

(57) ABSTRACT

The invention relates to a method of coating the inner wall of a pipe with a protective film, consisting in forming said protective film from at least one latex. The invention also relates to the use of at least one latex in order to form a film that is intended to coat the inner wall of a pipe.

The present invention relates to a method for. coating the internal wall of a pipeline with a protective film comprising the formation of this film starting from at least one latex.

The invention also relates to the use of a latex for forming a film intended for the coating of the internal wall of a pipeline for reducing or stopping the release of one or more constituents of the material of said pipeline into a liquid carried by the latter.

A pipeline, a pipe or a portion of pipe, the internal wall of which is coated with a film obtained from at least one latex, represents subsequent subject matters of the invention.

The method according to the invention can be applied in particular to a pipeline for supplying water, in particular drinking water, preferably having a temperature of less than approximately 30° C., in particular of less than or equal to approximately 20° C.

The method according to the invention has a particular advantageous application in the coating of metal pipelines, in particular lead pipelines.

This is because the recent decision of the European Union and of France to conform to the recommendations of the World Health Organization (WHO) by reducing the acceptable upper content limit for lead in drinking water from 50 to 10 μg/1 by 2013 requires organizations which manage distribution networks to rapidly find a solution which satisfies both the standards and private individuals.

The water at the outlet of a supplying station being always below this upper limit of 10 μg/l but becomes charged with the element lead on passing into old pipes.

In dwellings, the only solution, for the moment, often remains that of breaking through partitions, walls and fittings of the dwelling in order to gain access to the pipes.

It is thus advisable to develop a method for the nondestructive renovation of pipelines.

The film has to exhibit the following characteristics in order to meet the need identified:

impermeability to water and to lead,

adhesion to old lead, that is to say lead which is untreated and which has been subjected to attacks by drinking water, or which is possibly etched,

sufficient flexibility to withstand the pipe being twisted,

duration of effectiveness of greater than 10 years.

The polymer of which it is composed must meet the following requirements:

be prepared from chemical compounds (monomers, initiators, additives) which come within “food grade” standards, in the case of the coating of the internal wall of a pipeline intended for supplying drinking water,

exhibit good chemical resistance to water and to chlorine.

In addition, the method must be as simple as possible, in order to limit successive operations which increase the cost of the operation, be suitable for application in pipes which are both small in diameter and large in diameter, and with regard to a network comprising connections and junctions, and make possible the coating of the pipeline in a short period of time, in order to keep as short as possible the time during which the water is cut off.

Furthermore, the film must be formed under temperature conditions close to ambient temperature.

Lining with a polymer is already a technique employed in the field of pipeline internal coatings.

Thus, patent DE 4012605 discloses a process for the repair and sheathing of a wastewater pipeline, for public or industrial use. The coating is composed of a bituminous emulsion comprising a dispersion of poly(chlorobutadiene) and optionally of other polymers, such as natural resins, poly(vinyl propionate or acetate) or poly(vinyl alcohol). The dispersion is applied as a spray and drying is provided by a stream of hot air.

In the method of application EP 0 299 134, after abrasive cleaning, a liquid epoxy resin is circulated in the pipelines, ranging from the smallest towards the biggest diameters. The amount of resin which is sufficient, calculated for a pipeline or a stage, is propelled inside the pipeline with compressed air. Heating of the resin is provided by a stream of hot air.

French patent FR 2 728 652 relates to a method for the internal coating of a pipeline with a small diameter, in which an epoxy resin is propelled by a flexible plug with a diameter slightly less than that of the pipeline. The uniform movement of the resin+plug combination is provided by a slight difference in pressure.

Application GB 1 322 122 relates to a method for sealing the leaks in pipes, in particular by the application of natural or synthetic latex.

However, these methods did not make it possible to overcome a number of technical constraints, such as, for example, the need to dismantle supply faucets and to install temporary valves, or to heat the pipeline after emptying the excess latex.

Furthermore, the resins used generally have a short pot life, that is to say a short lifetime in the container for use, which does not make it very easy to use them.

It has now been found that the use of at least one latex for forming a film coating the internal wall of a pipeline makes it possible to overcome these constraints while meeting the official requirements as regards organic material which can be used in stationary plants for the distribution, treatment and production of water, in particular of water intended for consumption, namely, in particular, the upper limit on migration on the part of the finished material, the organoleptic quality of the water, bacterial inertia (no contribution to the formation of a biofilm) and the absence of cytotoricity.

According to the invention, the latex used to form the film is such that, when it is diluted to a solids content of 20% in demineralized water, its conductivity is less than 1.3 mS/cm.

In particular, the conductivity of said latex diluted to a solids content of 20% in demineralized water will be less than 1 mS/cm, preferably less than 0.9 mS/cm.

The term “latex diluted to a solids content of 20% in demineralized water” is understood to mean a latex brought to a solids content of 20% by addition of demineralized water.

The conductivity is measured using a conductivity meter at a temperature of 20° C.

The term “latex” is understood to mean, in the present description, a suspension of polymer particles which is generated in situ in a continuous phase composed of an aqueous solvent, preferably water or a water/cosolvent mixture, for example an alcohol.

Preferably, the diameter of the particles is of the order of 10 nm to 5 μm, in particular of 100 to 300 nm

To form the latex, use is more specifically made, according to the invention, as ethylenically unsaturated monomer, of the monomers chosen from styrene and its derivatives, butadiene, chloroprene, (meth)acrylic esters, vinyl esters or vinyl nitriles; said monomers are polymerized or copolymerized.

The term “(meth)acrylic esters” denotes the esters of acrylic acid or of methacrylic acid with hydrogenated or fluorinated C₁-C₁₂ alcohols, preferably C₁-C₈ alcohols. Mention may be made, among the compounds of this type, of methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate.

The vinyl nitrites include more particularly C₃-C₁₂ vinyl nitriles, such as, in particular, acrylonitrile and methacrylonitrile.

It should be noted that styrene can be replaced, in all or in part, by derivatives, such as α-methylstyrene or vinyltoluene.

The other ethylenically unsaturated monomers, which can be used alone or as mixtures or which can be copolymerized with the above monomers, are in particular:

vinyl esters of carboxylic acids, such as vinyl acetate, vinyl versatate or vinyl propionate,

vinyl halides,

ethylenic unsaturated mono- and dicarboxylic acids, such as acrylic acid, methacrylic acid, itaconic acid, maleic acid or fumaric acid, and the monoalkcyl esters of the dicarboxylic acids of the type cited with alkanols, preferably C₁-C₄ alkanols, and their N-substituted derivatives,

amides of unsaturated carboxylic acids, such as acrylamide, methacrylamide, N-methylolacrylamide, N-methylolmethacrylamide or N-alkylacrylamides,

ethylenic monomers comprising a sulfonic acid group and its alkali metal or ammonium salts, for example vinylsulfonic acid, vinylbenzenesulfonic acid, α-acrylamidomethylpropanesulfonic acid or 2-sulfoethylene methacrylate,

amides of vinylamine, in particular vinylformamide or vinylacetamide,

unsaturated ethylenic monomers comprising a secondary, tertiary or quaternary amino group or a nitrogen-comprising heterocyclic group, such as, for example, vinylpyridines, vinylimidazole, aminoalkyl (meth)acrylates and aminoalkyl(meth)acrylamides, such as dimethylaminoethyl acrylate or methacrylate, di(tert-butyl)aminoethyl acrylate or methacrylate, dimethylaminomethylacrylamide or dimethylaminomethylmethacrylamide. It is likewise possible to use zwitterionic monomers, such as, for example, sulfopropyl(dimethyl)aminopropyl acrylate.

monomers which make possible crosslinking during use, for example by the chemical, thermal or photochemical route, such as glycidyl methacrylate or dihydrodicyclopentadienyl acrylate.

When said pipeline is intended for supplying drinking water, said latex is preferably formed by polymerization or copolymerization of monomers of food grade. Lists of authorized monomers are available country by country.

Advantageous monomers of food grade are chosen from methacrylic esters, in particular n-butyl acrylate, methacrylic acid and its derivatives, and styrene and its derivatives.

According to a preferred aspect of the invention, said latex comprises a polymer or a copolymer having a film-forming temperature of between 0° C. and 20° C.

According to a preferred aspect of the invention, said latex comprises a polymer or a copolymer having a glass transition temperature (T_{g}) of less than 20° C. and more preferably still a glass transition temperature of between 0° C. and 10° C.

The latex which can be used for the purposes of the invention advantageously exhibits a high level of solids, in particular of greater than or equal to 20%, in particular from 30 to 50%. Another advantageous property of said latex is that of exhibiting a low level of coagulum, in particular of less than 10%, preferably of less than 0.1%. The level of solids and the level of coagulum are determined as indicated in example 1.

Preferably, the latex, prior to the use thereof in forming a film, is subjected to a purification treatment intended to reduce the concentration of water-soluble constituents in said latex.

The term “water-soluble constituent” is understood to mean, in the present description, residual monomers remaining in the solvent after polymerization, oligomers comprising approximately 2 to 10 monomer units, salt residues originating from the polymerization initiators, ions originating, from the polymerization buffer and, when surface-active agents are used during the formation of the latex, those of them which are not involved in the stabilization of the polymer particles, and any other constituent which remains in solution in the continuous phase on conclusion of the formation of the latex.

This purification treatment is advantageously carried out by dialysis and/or ultrafiltration. Said latex, on conclusion of such a purification treatment, exhibits a concentration of water-soluble constituents which is less than that of the latex obtained on conclusion of the polymerization or of the copolymerization.

According to an advantageous aspect, the method for coating the internal wall of a pipeline comprises the following stages:

a pipeline is filled using a latex,

said pipeline is emptied, so as to allow the excess latex to flow out and to form a layer of latex on the internal wall of the pipeline,

the layer of latex is heated, so as to form the protective film on the internal wall of said pipeline.

This method does not require any dismantling of the pipelines. Furthermore, the latex has a lifetime of several hours, making it particularly easy to use it.

The filling of the pipeline is, for example, carried out at ambient temperature.

The heating of the layer of latex, so as to form the protective film, can be carried out at a temperature of the order of 30 to 80° C.

The internal wall of the pipeline can be coated with several superimposed films of latex, in particular with two superimposed films of latex.

In this case, each of the films of latex is applied after drying the preceding film and each of the films has a thickness of approximately 50 to 500 μm, preferably 100 to 250 μm.

The filling of the pipeline can advantageously be carried out under pressure, for example a pressure of 2 to 50 Pa.

The coating of the internal wall of the pipeline can be carried out on the pipeline as is, without pretreatment of the latter.

Advantageously, when said pipeline is made of lead, a pretreatment using an acid can be carried out.

Use will advantageously be made of orthophosphoric acid, in particular at a molarity of 3N.

The invention also relates to a pipe or a portion of pipe coated with a film obtained starting from at least one latex, the coating of which is capable of being carried out by the method described above.

The pipes or portions of pipes thus coated exhibit improved properties of resistance to twisting in comparison with pipes coated with resins, such as certain epoxy resins, due to the elastic properties of the latex.

The latex capable of being used for the purposes of the invention can be obtained by conventional methods.

The reactants employed for producing a latex which can be used for the purposes of the invention are those conventionally used in the technology of emulsion polymerization. This technology involves four main constituents:

the dispersing medium (or continuous phase),

the surface-active agent(s); conventionally at a level of 0.01 to 10% by weight with respect to the monomer(s), depending on the type of stabilization,

the monomer(s),

the initiator, which is soluble in the dispersing medium, generally at a level of 0.5 to 2% by weight with respect to the monomer(s).

Other constituents may play a part in order to improve the properties of the final latex and/or to provide better control of the reaction of certain systems.

Mention may in particular be made of chain-transfer agents, buffers, for controlling the pH, and chelating agents.

The dispersing medium is generally composed of water or a mixture of water and cosolvent, such as an alcohol, in particular methanol, in which the constituents are dispersed or dissolved.

During the implementation of the synthesis, the surface-active agent is first dissolved in the aqueous phase, resulting in the formation of a micellar solution, if the concentration of surfactant is sufficient (critical micelle concentration).

Use will preferably be made of ionic surface-active agents, in particular anionic surface-active agents, such as sodium alkylsulfonates.

Use may also be made of nonionic surface-active agents and of macromolecular surface-active agents composed of block copolymers comprising a block based on poly(ethylene oxide) (PEO) bonded to a hydrophobic block composed of a polymer chain, such as poly(styrene) (ES) or poly(methyl methacrylate) (PMMA). The hydrophilic part can also be, instead of a PEO chain, an anionic or cationic hydrophilic block.

The monomers are added to this micellar solution and are stabilized by virtue of the surface-active agent.

The latexes which can be used for the purposes of the invention can result from the copolymerization of several monomers, in order to benefit from a broad palette of adjustable properties. These monomers can in particular be more or less water-soluble.

The initiators generally result from the category of the peroxides, in particular inorganic peroxides (H₂O₂, K₂S₂O₈)

The most widely used initiator is potassium persulfate or sodium persulfate. It can be used in combination with a redox couple, such as Fe²⁺/Fe³⁺, in order to be able to lower the polymerization temperature.

The buffers make it possible to keep the polymerization medium at a constant pH throughout the reaction. The regulation of the pH also makes it possible to avoid the formation of certain ionic combinations which would prevent the reaction from being carried to completion.

The chain-transfer agents are used to control the average molecular mass of the polymer and to prevent crosslinkings. Use will be made, for example, of an alkyl mercaptan of general formula R—SH.

The chelating agents may also prove to be necessary to render inactive certain metal ions capable of interfering with the polymerization and are chosen according to the type of ion and the pH of the medium.

Alternatively, it is possible to synthesize latexes in the absence of surface-active agents, in particular those comprising monomers carrying at least one carboxylic acid functional group, by adapting the parameters of the polymerization reaction, namely the stirring speed, the percentage by weight of monomer carrying at least one carboxylic acid functional group with respect to the total amount of monomers and the percentage by weight of initiator with respect to the total amount of monomers, so as to obtain latex particles of appropriate size.

The latexes which can be used for the purposes of the invention may be functionalized, that is to say that reactive or ionizable functional groups are covalently bonded to the surface of the particles.

This functionalization can be carried out:

by incorporation of reactive chemical groups carried by the radical initiator (sulfate or carboxylate are the commonest),

by stabilization of ionic or nonionic surface-active agents of “surfmer” type,

by postpolymerization chemical modification, or

by incorporation of functional monomers in the chains by copolymerization.

Use will advantageously be made of functionalization by carboxylic monomers, such as acrylic acid and/or methacrylic acid, for improving the adhesion and promoting the interactions of the latexes with the substrates, in particular metal substrates.

The latex can be synthesized in a closed reactor, in batch mode, in which all the components (water, surfactant, monomer, possible buffer) necessary for the synthesis are introduced into the reactor before initiating the reaction, the latter being carried out at the given temperature and under given stirring conditions.

It is also possible to carry out a synthesis in several stages and in particular the “seeded” polymerization, in which the synthesis begins with the polymerization of a “seed” composed of a portion of the monomers. For the addition of the second portion of the monomers, either under batch or semicontinuous conditions, the number of particles is constant during this period, the initiator being added in parallel.

It is also possible to use, for the purposes of the invention, a commercially available latex.

Preferably, said latex will be subjected to a purification treatment by dialysis and/or ultrafiltration prior to the use thereof for the coating of the internal wall of a pipeline.

The latex, diluted, for example, to 20%, is introduced into a recirculation tank and is passed into an ultrafiltration module at a rate of between 1 and 5 m/s at ambient temperature and a pressure of between 1 and 5 bar is applied.

The ultrafiltration module can be used with inorganic or organic membranes, with a cutoff threshold (size of the pores) suitable for the latex used.

The latex is purified by diafiltration until the required purity is obtained.

The latex is regarded as sufficiently purified from the moment when the conductivity approaches the threshold at which it is constant.

This value depends on the latexes used and on their state of initial dilution.

Use may also be made of other purification techniques, in particular techniques involving absorption on a resin.

By way of example, for a latex diluted to approximately 20% in demineralized water, the latex is regarded as sufficiently purified when its conductivity is less than 1.3 mS/cm, preferably less than 1 mS/cm and more preferably still less than 0.9 mS/cm.

The invention is illustrated by the examples below.

### EXAMPLE 1

### Synthesis of Terpolymer Latex in Batch Mode 1.1/Equipment and Conditions of the Reaction

All the reactions were carried out in a 250 ml unjacketed “Sovirel” reactor with a stirrer of anchor type. Due to the volume of the reactor, the total weight (reactants+water) involved in the reaction is 150 g.

The regulation of the temperature is provided by means of a water bath thermostatically controlled at a temperature of 70° C. The stirring can be adjusted to different values between 0 and 1000 rev/min. The stirring is most commonly from 250 to 300 rev/min.

The reactor is surmounted by a reflux condenser and by an inlet for nitrogen, which makes possible the degassing of all the system and the solutions.

For the batch shot and semicontinuous syntheses, the addition is carried out using syringes and syringe drivers, making it possible to add, to the reactor, the monomers alone or in emulsion at a variable rate of between 1.45 and 145 ml/h.

The kinetics are monitored by taking regular samples and the reaction is halted when the degree of conversion reaches 100% or when it stabilizes (for incomplete reactions)

The latex is placed under nitrogen bubbling for half an hour and is cooled to ambient temperature.

### 1.2/Determination of the Level of Solids and of the Level of Coagulum

The level of solids Ls is determined by the dry extracts method. A withdrawn weight w_{L} of latex is left at 120° C. to constant weight. The weight of dry polymer w_{D} obtained after complete evaporation makes it possible to calculate the level of solids:

$$Ls = \frac{{w}_{D}}{{w}_{L}}$$

The level of coagulum represents the part of the monomers introduced into the reactor which is found in the form of agglomerated particles. Thus:

$$\% coagulum = \frac{{w}_{coagulum}}{{w}_{monomert}}$$

The coagulum is separated from the latex by filtration through a sieve.

### 1.3/Determination of the Degree of Conversion

The degree of conversion Dc is defined by the ratio of the real level of solids of the latex to the theoretical level of solids of the latex, corrected for the initial level of solids, according to the following formula:

$$Dc = \frac{Ls - {Ls}_{1}}{{Ls}_{th} - {Ls}_{i}}$$

with

Ls: real level of solids, determined by dry extract

Lsᵢ: initial level of solids, due to the initiator, to the surfactants and to the possible buffer

Lsₜₕ: theoretical level of final solids, calculated from the amounts introduced

### 1.4/Determination of the Size of the Particles

The size of the particles is determined by quasielastic light scattering on a device of Coulter N4+type from Coultronics.

### 1.5/Sytesis of the Latex

The following abbreviations are used below:

| | |
|---|---|
| BuA | n-butyl acrylate |
| MAA | methacrylic acid |
| KPS | potassium persulfate |
| SDS | sodium dodecyl sulfate |
| Sty | styrene |

The proportions of the monomers for the synthesis of poly(styrene-co-butyl acrylate-co-nethacrylic acid) terpolymers are set at 37/58/5.

The stirring is fixed at 300 rev/min. The typical recipe, for a level of solids of 50%, for this series of latexes is shown below:

| | | |
|---|---|---|
| Sty (Atochem) | 29.6 | g |
| BuA (Fluka) | 46.4 | g |
| MAA (Aldrich) | 4 | g |
| SDS (Fluka) | 0.4 | g (0.5% of the monomers) |
| Water | 80 | g |
| KPS (Prolabo) | 0.6 | g (0.75% of the monomers) |
| NaHCO₃ (Fluka) | 0.328 | g |

The characteristics of the latexes obtained are presented in table 1 below:

TABLE 1

| | | | | Size of the | | |
|---|---|---|---|---|---|---|
| Latex | NaHCO₃ | Real | | particles | | |
| No. | buffer* | Ls | % coagulate | D_{h,w} (nm) | PI** | T_{g} (° C.) |
| L1 | 0.75% | 34.8% | 2.9% | 153 | 0.02 | 12 |
| L2 | 0.41% | 49.0% | 2.6% | 177 | 0.07 | 14 |
| L3 | 1% | 48.6% | 8.1% | 245 | 0.04 | 13 |

*as % by weight with respect to the monomers
**polydispersity index, measured with the Coulter N4 + CPI device (Coultronics)

### 1.6/Purification of the Latexes

The slightly diluted latex (level of solids of 20 to 30%) is introduced into a flexible cellulose dialysis tube with a cutoff threshold of 50 000 Da (Spectra/Pore 7) and then immersed in distilled water.

Dilution is necessary due to the difference in osmotic pressure on either side of the membrane.

The exchange water is replaced every twelve hours at the beginning and then every day until a constant conductivity for this water is obtained.

The overall purification operation can thus last up to 15 or 20 days, in particular for the latexes for which total conversion has not been achieved.

### EXAMPLE 2

### Synthesis of a Latex in Batch Mode with Controlled Feeding of Functionalizing Monomer

Latexes with the same overall composition were synthesized according to the “modified” batch shot method, that is to say that the addition of the remainder of the monomers, including the acid, is carried out continuously and not all at once after approximately 90% conversion of the majority of the monomers introduced in batch mode.

The seed is composed of styrene and of butyl acrylate in the proportions 41/59. It is composed of close to 68% of all the monomers.

The typical composition of the latexes obtained is given in table 2:

TABLE 2
Typical composition

| | | % with | % with | |
|---|---|---|---|---|
| | | respect to | respect to | |
| | | the seed or | the total of | Weight |
| | Constituents | to the shot | the monomers | (g) |
| Seed | Water | — | — | 100 |
| | SDS | — | 0.5 | 0.28 |
| | KPS | — | 0.75 | 0.41 |
| | Sty | 41 | 28 | 15.35 |
| | BuA | 59 | 40 | 21.9 |
| Delayed | Sty | 28.2 | 9 | 5 |
| addition | BuA | 56.3 | 18 | 10 |
| (shot) | MAA | 15.5 | 5 | 2.75 |

The latex L4 below was synthesized by adding the functionalized monomer (MAA) at a rate of 20 ml/h, the addition being carried out 1 hour after the beginning of the polymerization.

Its characteristics are given in table 3 below:

TABLE 3

| Composition in | | | | | |
|---|---|---|---|---|---|
| monomers as % | | | D_{h,w} | | T_{g} |
| by weight | Real Ls | % coagulate | (nm) | PI | (° C.) |
| Sty/BuA/MAA | 34.5% | 4.8% | 109 | 0.06 | 16 |
| 37/58/5 | | | | | |

The latex L4 is subjected to purification by dialysis as shown in example 1.

### EXAMPLE 3

### Study of the Properties of Resistance to Water as a Function of the Dialysis Treatment of the Latex Film

The penetration of water inside the film can contribute to the diffusion of the lead and, by accumulation at the film/substrate interface, is capable of producing defects in adhesion and problems of delamination of the coating.

A dialyzed or nondialyzed 37/59/3 styrene/butyl acrylate/acrylic acid latex was used.

The film was prepared on a Teflon® sheet using a film drawer resulting in a wet thickness of 500 μm. The level of solids of the latex applied is between 30 and 50%, depending on the viscosity of the latter. After drying, the thickness of the film is of the order of 200 μm.

Drying is carried out in two stages, the latex deposited on Teflon® being first left at 20° C. for 20 minutes and then placed at 50° C. for one hour.

The film is subsequently left at 20° C. for three hours in order to simulate use on a pipeline in real surroundings within the space of a 10-hour day. It is subsequently cut up into six examples of 9 cm² squares.

The sensitivity to water of the films is evaluated by gravimetry, subsequent to continuous immersion in water at 20° C., on the films free from any support. The exposed surface area is thus twice the real surface area of films deposited on a substrate.

In order to visualize the amount of water absorbed M(t) relative to the weight of polymer M₀ in contact with the water, the graph:
M(t)/M₀=f(t),

with

M(t)=weight of water absorbed at the time t, in g,

M₀=weight of the polymer in contact with the water, in g,

t=time, in h,

was plotted.

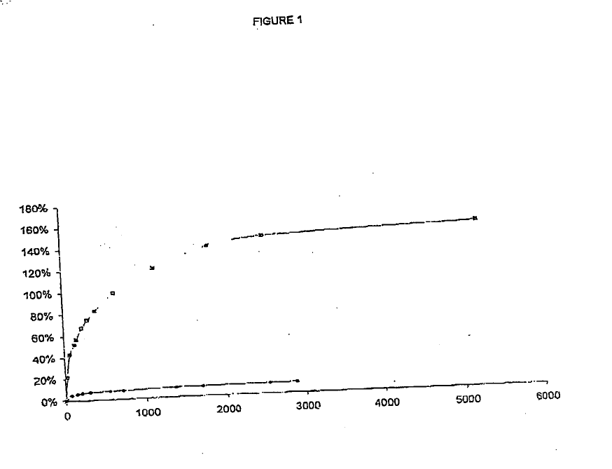

The graph M(t)/M₀ (expressed as percentage)=f(t) (expressed as h) is represented in FIG. 1. The following symbols are used:

♦-represents the dialyzed latex,

▪-represents the nondialyzed latex.

This graph shows that, for the same latex, the absorption of water is very low and remains constant when the latex has been dialyzed.

### EXAMPLE 4

### Test of Diffusion of Lead into a Pipeline Coated with a Latex Film

Sections of pipeline 5 cm in length and 2 cm in diameter, resulting from dismantled networks, were used.

In a first step, the pipeline is completely filled with a 3N phosphoric acid solution. After a contact time of 10 to 15 minutes, the pipeline is emptied, rinsed and dried at ambient temperature.

Coating with the latex is carried out in the same way, without the need to allow the latex to stand. The pipe is filled and then emptied without waiting. No excess latex should remain in the pipe.

The ends of the pipe are also coated with latex in order to avoid any inopportune contact of the lead with the water.

This first layer is dried for one hour at 50° C. in the vertical position in a thermostatically controlled chamber. On conclusion of this first drying cycle, the second coating is applied in the same way, after a cooling time of approximately 5 to 10 minutes.

The ends are protected and isolated by dipping them in hot paraffin over a height of approximately 5 mm.

After the complete coating stage (depending on the number of layers), the pipe section is left at 20° C. for is 3 hours. It is first sealed using Parafilm®, in order to prevent evaporation, and placed in a chamber thermostatically controlled at 30° C.

For all the filling operations, one of the ends of the pipe is sealed using several layers of Parafilm®.

A preliminary test consists in leaving the water introduced into these pipeline sections to stand for 2 days. Depending on the concentration of lead measured, the pipeline is rinsed and again filled with distilled water. The pipeline this second time is left to stand for 15 days.

The concentration of lead is measured, after agitating the assembly at the end of the period during which the pipeline has been left to stand, on 5 ml samples using a Scanning SA-1000 analyzer (Palintest Instruments).

The results obtained after 2 days and after 15 days are reported in table 4 below:

TABLE 4
Concentration of lead after leaving to stand
for 2 days and 15 days

| | | | [Pb²⁺] |
|---|---|---|---|
| | | [Pb²⁺] (μg/l) | (μg/l) at |
| Latex | Ls* (%) | at 2 days | 15 days |
| L2 | 41.8 | 7 | 10 |
| L3** | 42.8 | 6 | 7 |
| L4 | 30.6 | 6 | 7 |
| Styrene/butyl | 48.6 | <10 | 10 |
| acrylate/acrylic | | | |
| acid 37/59/3 | | | |

*level of solids after purification
**3 layers

1. Method for coating the internal wall of a pipeline with a protective film comprising the formation of said protective film starting from at least one latex, characterized in that said latex, diluted to a solids content of 20% in demineralized water, exhibits a conductivity of less than 1.3 mS/cm.

2. Method according to claim 1, characterized in that said latex, diluted to a solids content of 20% in demineralized water, exhibits a conductivity of less than 1 mS/cm.

3. Method according to claim 1 characterized in that said latex, diluted to a solids content of 20% in demineralized water, exhibits a conductivity of less than 0.9 mS/cm.

4. Method according to claim 1 characterized in that said pipeline is intended for supplying water, the latter having a temperature of less than approximately 30° C., preferably of less than or equal to approximately 20° C.

5. Method according to claim 1, characterized in that said pipeline is intended for supplying drinking water.

6. Method according to claim 1, characterized in that said pipeline is made of metal.

7. Method according to claim 1, characterized in that said pipeline is made of lead.

8. Method according to claim 1, characterized in that the latex is formed by polymerization or copolymerization of ethylenically unsaturated monomers selected from the group consisting of styrene and its derivatives, butadiene, chloroprene, (meth)acrylic esters, vinyl esters and vinyl nitrites.

9. Method according to claim 8 wherein said monomers are selected from the group consisting of esters of acrylic acid or of methacrylic acid with hydrogenated or fluorinated C₁-C₁₂ alcohols.

10. Method according to claim 1, characterized in that the latex is formed by polymerization or copolymerization of monomers selected from the group consisting of methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate and isobutyl methacrylate.

11. Method according to claim 1, characterized in that the latex is formed by polymerization or copolymerization of a monomer which is a C₃-C₁₂ vinyl nitrile.

12. Method according to claim 1, characterized in that the latex is formed by polymerization or copolymerization of ethylenically unsaturated monomers selected from the group consisting of:
vinyl esters of carboxylic acids,
vinyl halides,
ethylenic unsaturated mono- and dicarboxylic acids and the monoalkyl esters of the dicarboxylic acids with C₁-C₄ alkanols and their N-substituted derivatives,
amides of unsaturated carboxylic acids,
ethylenic monomers comprising a sulfonic acid group and its alkali metal or ammonium salts,
amides of vinylamine,
unsaturated ethylenic monomers comprising a secondary, tertiary or quaternary amino group or a nitrogen-comprising heterocylic group,
zwitterionic monomers,
monomers which make possible crosslinking during use, for example by the chemical, thermal or photochemical route,
said ethylenically unsaturated monomers being used alone or copolymerized With monomers chosen from styrene and its derivatives, butadiene, chloroprene, (meth)acrylic esters, vinyl esters and vinyl nitrites.

13. Method according to claim 1, characterized in that the latex is formed by polymerization or copolymerization of monomers of food grade.

14. Method according to claim 1, characterized in that the monomers used to form the latex are selected from the group consisting of acrylic acid and its derivatives, methacrylic acid and its derivatives, and styrene and its derivatives.

15. Method according to claim 1, characterized in that said latex comprises a polymer or a copolymer having a film-forming temperature of between 0° C. and 20° C.

16. Method according to claim 1, characterized in that said latex comprises a polymer or a copolymer having a glass transition temperature (T_{g}) of less than 20° C.

17. Method according to claim 1, characterized in that said latex comprises a polymer or a copolymer having a glass transition temperature (T_{g}) of between 0 and 10° C.

18. Method according to claim 1, characterized in that the diameter of the latex particles is between 10 nm and 5 μm, optionally between 100 and 300 nm.

19. Method according to claim 1 characterized in that said latex has a level of solids of greater than or equal to 20%, optionally of 30 to 50%.

20. Method according to claim 1 characterized in that said latex has a level of coagulum of less than 10%, optionally of less than 0.1%.

21. Method according to claim 1, characterized in that the latex, prior to the use thereof in forming a film, is subjected to a purification treatment intended to reduce the concentration of water-soluble constituents in said latex.

22. Method according to claim 21, characterized in that the purification treatment is carried out by dialysis and/or ultrafiltration.

23. Method according to claim 21, characterized in that said latex, on conclusion of this treatment, exhibits a concentration of water-soluble constituents which is less than that of the latex obtained on conclusion of the polymerization or of the copolymerization.

24. Method according to claim 1, characterized in that it comprises the following stages:
a pipeline is filled using a latex,
said pipeline is emptied, so as to allow the excess latex to flow out and to form a layer of latex on the internal wall of the pipeline,
the layer of latex is heated, so as to form the protective film on the internal wall of said pipeline.

25. Method according to claim 24, characterized in that the filling of the pipeline is carried out at ambient temperature.

26. Method according to claim 24 characterized in that the layer of latex is heated at a temperature of the order of 30 to 80° C.

27. Method according to claim 1, characterized in that the internal wall of said pipeline is coated with several superimposed films of latex.

28. Method according to claim 1, characterized in that the internal wall of said pipeline is coated with several superimposed films of latex and each of the films of latex is applied after drying the preceding film.

29. Method according to claim 1, characterized in that the internal wall of said pipeline is coated with several superimposed films of latex and each of the films has a thickness of between approximately 50 and 500 μm, optionally 100 to 250 μm.

30. Method according to claim 1, characterized in that the internal wall of said pipeline is coated with two superimposed films of latex.

31. Method according to claim 1, characterized in that the filling of the pipeline is carried out under pressure.

32. Method according to claim 1, characterized in that the filling of the pipeline is carried out under a pressure of the order of 2 to 50 Pa.

33. Method according to claim 1, characterized in that said is made of metal and pipeline is, prior to the coating of its internal wall, subjected to a treatment using an acid.

34. Method according to claim 1, characterized in that said pipeline is made of metal and is, prior to the coating of its internal wall, subjected to a treatment using ortho-phosphoric acid.

35. A method for reducing or stopping the release of one or more constituents of the material of a pipeline into a liquid carried by this pipeline, wherein at least one latex is used for forming a film intended for the coating of the internal wall of a pipeline.

36. Pipe or portion of pipe, characterized in that its internal wall is coated with a film obtained from at least one latex, said latex exhibiting a conductivity of less than 1.3 mS/cm, when it is diluted to a solids content of 20% in demineralized water.

37. Pipe or portion of pipe according to claim 36, characterized in that said coating is capable of being carried out by the method according to claim 1.
